(19) United States
(12) Patent Application Publication
(10) Pub. No.: US 2026/0129249 A1
(43) Pub. Date: May 7, 2026

(54) INTERACTION MESSAGE PRESENTATION

(71) Applicant: Beijig Zitiao Network Technology Co., Ltd., Beijing (CN)

(72) Inventors: Jiancheng GU, Beijing (CN); Qingyu MENG, Beijing (CN); Zihan WANG, Sydney (AU)

(21) Appl. No.: 19/383,437

(22) Filed: Nov. 7, 2025

(30) Foreign Application Priority Data
Nov. 7, 2024 (CN) 202411587302.3

(51) Int. Cl. H04N 21/2187; H04N 21/242; H04N 21/488

(52) U.S. Cl. CPC H04N 21/2187; H04N 21/242; H04N 21/4882

(57) ABSTRACT

The embodiment of the disclosure relates to methods, apparatuses, devices and storage media for presenting an interaction message. The method provided by the disclosure includes: presenting, in a live streaming interface, an interaction message in a first interaction sequence, the interaction message in the first interaction sequence being an interaction message of a predetermined type, and the interaction message in the first interaction sequence being received by a client from a server; sending, to the server, an update request for the first interaction sequence, the update request indicating at least first sequence version information corresponding to the first interaction sequence; determining, based on an update response for the update request, received from the server, whether the first interaction sequence is to be updated; and presenting, based on a result of the determination of the update for the first interaction sequence, the interaction message of the predetermined type in the live streaming interface.

### CROSS-REFERENCE

This application claims priority to Chinese Patent Application No. 2024115873023 filed on Nov. 7, 2024, and entitled “METHODS, APPARATUSES, DEVICES AND STORAGE MEDIA FOR PRESENTING INTERACTION MESSAGE”.

### FIELD

Example embodiments of the present disclosure generally relate to the field of computer technologies, and more particularly; to interaction message presentation.

### BACKGROUND

Interaction messages in live streaming are of a plurality of types, including common interaction messages and special interaction messages (for example, paid comments or administrator comments) and/or the like, and they each carry different information and values. Different types of interaction messages are also distinguished in a presentation style. For example, a common interaction message may appear in a basic text form, and a special interaction message may have a more striking color, font or background, or even be accompanied by an animation effect, to ensure that it stands out in many interaction messages. These differentiated presentation styles not only enrich the interaction experience of the live streaming room but also meet the diversified expression requirements of users.

However, current presentation modes of interaction messages are easily affected by a network environment, and thus accuracy of these interaction messages in terms of a presentation time is difficult to meet expectations.

### SUMMARY

In a first aspect of the present disclosure, a method of presenting an interaction message is provided and implemented at a client. The method comprises: presenting, in a live streaming interface, an interaction message in a first interaction sequence, the interaction message in the first interaction sequence being an interaction message of a predetermined type, and the interaction message in the first interaction sequence being received by the client from a server; sending, to the server, an update request for the first interaction sequence, the update request indicating at least first sequence version information corresponding to the first interaction sequence; determining, based on an update response for the update request, received from the server, whether the first interaction sequence is to be updated; and presenting, based on a result of the determination of the update for the first interaction sequence, the interaction message of the predetermined type in the live streaming interface.

In a second aspect of the present disclosure, a method of presenting an interaction message is provided and implemented at a server. The method comprises: receiving an update request from a client, the update request indicating at least first sequence version information corresponding to a first interaction sequence, an interaction message in the first interaction sequence being an interaction message of a predetermined type, and the interaction message in the first interaction sequence being used to be presented in a live streaming interface at the client; generating an update response for the update request based on a difference between the first sequence version information and second sequence version information corresponding to a second interaction sequence at the server; and sending the update response to the client.

In a third aspect of the present disclosure, an apparatus for presenting an interaction message is provided and applied at a client. The apparatus comprises: a first presenting module configured to present, in a live streaming interface, an interaction message in a first interaction sequence, the interaction message in the first interaction sequence being an interaction message of a predetermined type, and the interaction message in the first interaction sequence being received by the client from a server; a request sending module configured to send, to the server, an update request for the first interaction sequence, the update request indicating at least first sequence version information corresponding to the first interaction sequence; an updating module configured to determine, based on an update response for the update request, received from the server, whether the first interaction sequence is to be updated; and a second presenting module configured to present, based on a result of the determination of the update for the first interaction sequence, the interaction message of the predetermined type in the live streaming interface.

In a fourth aspect of the present disclosure, an apparatus for presenting an interaction message is provided and applied at a server. The apparatus comprises: a request receiving module configured to receive an update request from a client, the update request indicating at least first sequence version information corresponding to a first interaction sequence, an interaction message in the first interaction sequence being an interaction message of a predetermined type, and the interaction message in the first interaction sequence being used to be presented in a live streaming interface at the client; an update response generating module configured to generate an update response for the update request based on a difference between the first sequence version information and second sequence version information corresponding to a second interaction sequence at the server; and an update response sending module configured to send the update response to the client.

In a fifth aspect of the present disclosure, an electronic device is provided. The device comprises: at least one processor; and at least one memory coupled to the at least one processor and storing instructions for execution by the at least one processor. The instructions, when executed by the at least one processor, cause the device to perform the method of the first or second aspect.

In a sixth aspect of the present disclosure, a non-transitory computer-readable storage medium is provided. The non-transitory computer-readable storage medium stores a computer program, and the computer program is executed by a processor to implement the method of the first or second aspect.

In a seventh aspect of the present disclosure, a computer program product is provided. The computer program product comprises computer-executable instructions that, when executed by a processor, implement the method according to the first or second aspect of the present disclosure.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description in conjunction with the accompanying drawings. In the drawings, the same or similar reference numbers refer to the same or similar elements, where:

FIG. 1 illustrates a schematic diagram of an example environment in which embodiments of the present disclosure can be implemented;

FIG. 2 illustrates a schematic diagram of an example for presenting an interaction message according to some embodiments of the present disclosure;

FIG. 3 illustrates a schematic diagram of an example of interaction between a client and a server according to some embodiments of the present disclosure;

FIG. 4 illustrates a schematic diagram of an example of updating a first interaction sequence according to some embodiments of the present disclosure;

FIG. 5 illustrates a schematic diagram of an example of a first instant message according to some embodiments of the present disclosure;

FIG. 6 illustrates a schematic diagram of an example of an interaction message in a second interaction sequence at a server according to some embodiments of the present disclosure;

FIG. 7 illustrates a flowchart of an example process of a method of presenting an interaction message implemented at a client side according to some embodiments of the present disclosure;

FIG. 8 illustrates a flowchart of an example process of a method of presenting an interaction message implemented at a server side according to some embodiments of the present disclosure;

FIG. 9 illustrates a schematic structural block diagram of an apparatus for presenting an interaction message according to some embodiments of the present disclosure;

FIG. 10 illustrates a schematic structural block diagram of an apparatus for presenting an interaction message according to some embodiments of the present disclosure; and

FIG. 11 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are only for the purpose of example and are not intended to limit the scope of the present disclosure.

It should be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first.” “second.” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, handled, forwarded, used and/or the like, all of which are performed on the premise of the user awareness and confirmation. Accordingly, when implementing the embodiments of the present disclosure, the types of data or information, the usage scope, the usage scenario, and the like that may be involved should be notified to the user in an appropriate manner according to the relevant laws and regulations, and the authorization of the user is obtained. The specific notification and/or authorization manner may vary according to actual situations and application scenarios, and the scope of the present disclosure is not limited in this respect.

The solutions in the present specification and the embodiments, if personal information processing is involved, may perform the processing on the premise of having a legality basis (for example, authorization from the subject of the personal information, or necessary for performing a fulfillment contract), and perform the processing only within a specified or agreed range. The user rejecting personal information other than necessary information required by a basic function will not affect the use of the basic function by the user.

As briefly described above, current live streaming includes various types of interaction messages such as common interaction messages and special interaction messages (for example, paid comments or administrator comments), and the accuracy of these interaction messages (especially special interaction messages with higher requirements for timeliness) in terms of a presentation time is difficult to meet expectations.

Specifically, taking a presentation of the type of a special interaction message in the live streaming as an example, in a conventional presentation solution, a server will be responsible for generating and managing a special interaction sequence, and the special interaction sequence records a display duration of each special interaction message and its position in the current sequence. If a new special interaction message needs to be presented, or an existing special interaction message needs to be deleted, modified and inserted, the server updates the special interaction sequence, and synchronizes the latest special interaction sequence to a relevant client in the live streaming through an instant messaging message (IM message). After receiving the IM message delivered by the server, the client presents a corresponding interaction message according to an indication of the message content.

However, due to instability of the network environment, there may be uncertainty in a push interval of the IM message. In this case, a start time and/or presentation duration of the special interaction message is affected, and the special interaction message cannot be presented according to the expected setting. As an example, when the client presents the special interaction message A, if an IM message carrying the special interaction message B arrives in advance, the presentation of the special interaction message A is interrupted in advance; otherwise, if the IM message carrying the special interaction message B is delayed, the presentation duration of the special interaction message A is prolonged.

In view of this, embodiments of the present disclosure provide a solution for presenting an interaction message, which is implemented at a client. According to the solution of the present disclosure, the client presents an interaction message in a first interaction sequence in a live streaming interface. The interaction message in the first interaction sequence is an interaction message of a predetermined type, and the interaction message in the first interaction sequence is received by the client from the server. The client sends an update request for the first interaction sequence to the server, and the update request indicates at least first sequence version information corresponding to the first interaction sequence. Upon receiving an update response for the update request from the server, the client determines whether the first interaction sequence is to be updated based on the update response for the update request received from the server. After obtaining a result of the determination of the update for the first interaction sequence, the client presents the interaction message of the predetermined type in the live streaming interface based on the result of the determination of the update for the first interaction sequence.

As will be more clearly understood from the following description, the solution of the present disclosure is intended to solve the issue existing in a current scheme of a presentation of a live streaming interaction message, especially the issue that the accuracy of a special interaction message (such as a paid comment or an administrator comment) in terms of a presentation time is difficult to guarantee. Specifically, according to the solution of the present disclosure, a client sends an update request for a first interaction sequence to a server and actively synchronizes the first interaction sequence with the second interaction sequence at the server based on an update response. This mechanism effectively reduces an error of the presentation of the interaction message caused by the push uncertainty of an IM message, such as the special interaction message is interrupted or prolonged in advance and improves accuracy of the presentation of the interaction message.

Various example implementations of this solution will be described in detail below in conjunction with the accompanying drawings.

### Example Environment

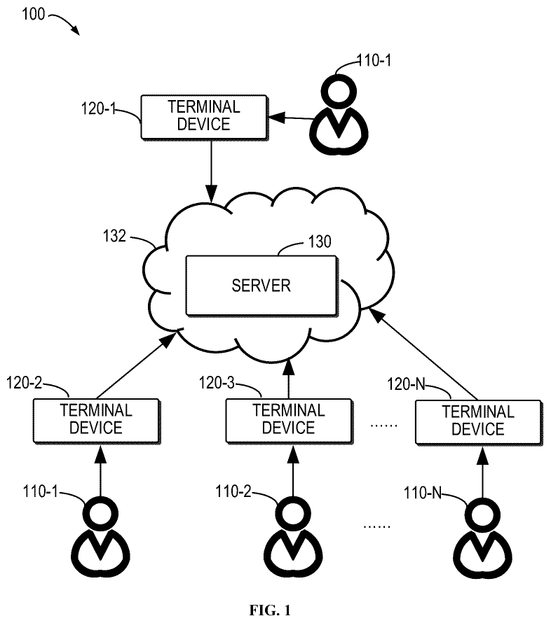

FIG. 1 illustrates a schematic diagram of an example environment 100 in which embodiments of the present disclosure can be implemented. In the environment 100, one or more users 110-1, 110-2, 110-3, . . . , 110-N, through their respective associated client(s), can view live streaming, participate in interactions of target live streaming, and/or the like. The users 110-1, 110-2, 110-3, . . . , 110-N can be collectively or individually called user(s) 110, and the clients 120-1, 120-2, 120-3, . . . , 120-N can be collectively or individually called client(s) 120. In all the users 110, one or more users, such as a user 110-1, may establish a target live streaming and initiate the live streaming through its associated client 120-1.

In some scenarios, the user 110-1 initiating the live streaming may also be referred to as a streamer, a live streaming party, or a live streaming management party of the target live streaming. One or more other users 110 may include a participant 110-N to represent a user participated in a live streaming interaction initiated by the streamer. As an example, the participant may further include a viewer, a listener or a viewer of the target live streaming, and the like.

As an example, the user 110 may initiate an interaction message of a predetermined type through the client 120. Such an interaction message will be obtained by the server 130 and added to a corresponding second interaction sequence. The client 120 includes a first interaction sequence for storing interaction messages of the predetermined type. The client 120 can synchronize the first interaction sequence with a second interaction sequence at the server 130 by at least actively polling, so that the user 110 can accurately view the interaction message of the predetermined type in time.

In some embodiments, the client 120 may be installed with an application capable of providing live streaming services, or an accessible website capable of providing live streaming services. The user 110 may operate the client 120 to access a corresponding application or website. Correspondingly, the client 120 may present a corresponding live streaming interface, for example, which may provide live streaming content of a live streaming room, for example, audio live streaming content or video live streaming content.

In some embodiments, the client 120 may further communicate with the server 130 through a network 132, to enable provision of live streaming services. The server 130 may provide such functions as management, configuration, and maintenance of an application or a website. In some embodiments, the server 130 may store data generated during the target live streaming, including live streaming interaction data generated during the live streaming interaction.

The client 120 may be implemented in any type of terminal devices. As an example, a terminal device may include, but is not limited to, a mobile terminal, a fixed terminal, or a portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a television receiver, a radio broadcast receiver, an electronic book device, a gaming device, or any combination of the foregoing, including accessories and peripherals of these devices or any combination thereof. In some embodiments, the terminal device can also support any type of interfaces (such as a “wearable” circuit and/or the like) for a user. The server 110 may be various types of computing systems/servers capable of providing computing power, including, but not limited to mainframes, edge computing nodes, computing devices in a cloud environment, and the like.

It should be understood that the structures and functions of various elements in the environment 100 arc described only for the purpose of illustration and do not imply any limitation to the scope of the present disclosure.

### Example Interaction

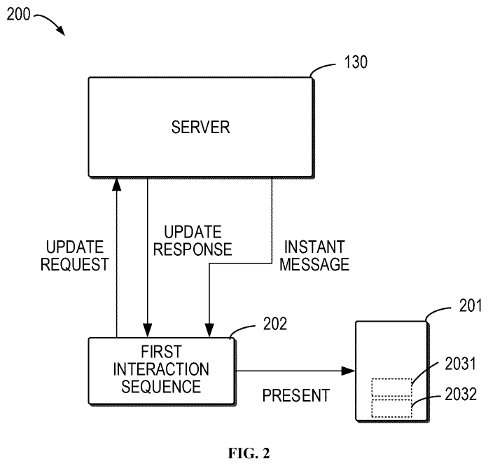

FIG. 2 illustrates a schematic diagram of an example 200 for presenting an interaction message according to some embodiments of the present disclosure. The example of FIG. 2 will be described with reference to FIG. 1. In FIG. 2, a first interaction sequence 220 is maintained at a certain client 120. In the live streaming interface 201 of the target live streaming, the client 120 presents interaction messages in the first interaction sequence 202, and the interaction messages in the first interaction sequence 202 are interaction messages of a predetermined type. These interaction messages are received by the client 120 from the server 130.

As an example, an interaction message may refer to a text message (for example, a comment in the target live streaming), a picture message, or an interaction message (for example, like) sent in response to another interaction event. As an example, in the target live streaming, the interaction message of the predetermined type may be an interaction message for which the user 110 of the live streaming has performed an additional operation on the basis of sending of the interaction message. Such interaction message may also be referred to as a special interaction message. For example, the interaction message of the predetermined type may be, for example, a paid comment or an administrator comment. The presentation mode of the interaction message of the predetermined type may be different from the presentation mode of a normal interaction message or interaction information in the target live streaming.

As an example, the interaction message of the predetermined type may be presented in a particular region of the live streaming interface 201 (e.g., a first region 2031 shown in FIG. 2), while the normal interaction message or interaction information is presented in a further region (e.g., a second region 2032 shown in FIG. 2).

As an example, the first interaction sequence 202 is used to store interaction messages of a predetermined type received by the client 120. Each interaction message of the predetermined type has a respective message content. In addition, depending on a specific presentation requirement of the interaction message or related information of the user 110 initiating the interaction message of the predetermined type, and an order of interaction messages, each interaction message of the predetermined type also has a respective presentation start time and presentation duration. The client 120 may extract an interaction message for presentation from the first interaction sequence 202 according to a presentation start time. Each interaction message of the predetermined type is presented in the live streaming interface 201 according to its respective presentation start time in order. After the presentation is complete, the interaction message that has been presented may be deleted from the first interaction sequence 202.

As an example, the viewing experiences of the streamer and each participant in the target live streaming for interaction messages of a predetermined type tend to be consistent. For example, within a same period, the interaction message of the predetermined type seen by the streamer and each participant in the target live streaming should be the same.

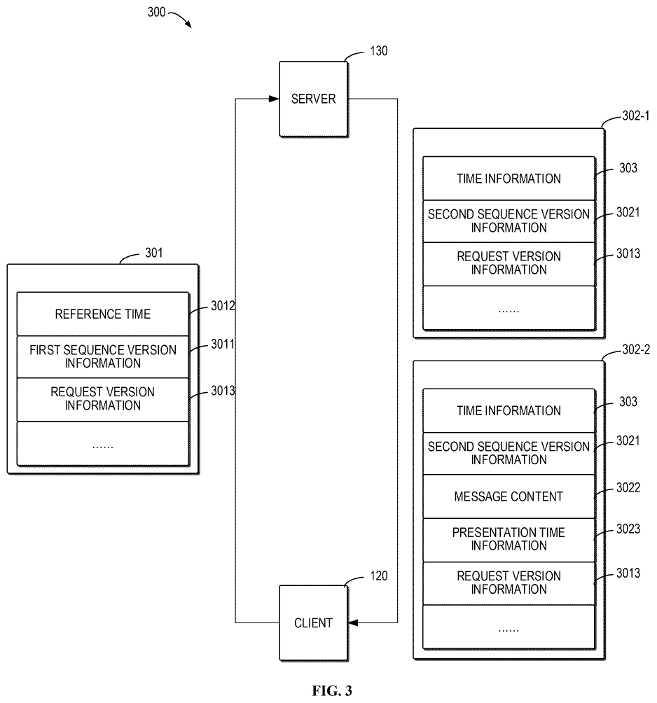

FIG. 3 illustrates a schematic diagram of an example 300 of interaction between a client and a server according to some embodiments of the present disclosure. With reference to FIG. 1, FIG. 2, and FIG. 3, the client 120 sends an update request 301 for the first interaction sequence 202 to the server 130, where the update request 301 at least indicates first sequence version information 3011 corresponding to the first interaction sequence 202. Then, the client 120 determines whether the first interaction sequence is to be updated based on an update response for the update request 301 received from the server 130.

In an embodiment of the present disclosure, a client in a live streaming is allowed to synchronize an interaction message of a specific type with a server through a polling mechanism. As an example, the client 120 may periodically send the update request 301. For example, the client 120 may repeatedly send the update request 301 at a certain time interval. This update request 301 may also be referred to as a polling request. The first sequence version information 3011 may be an identifier about a current state of the “first interaction sequence 202”. The first sequence version information 3011 may be a number, a timestamp, a hash value, or any other information capable of uniquely identifying the current version of the interaction sequence.

The server 130 receives the update request 301 from the client 120. Then, the server 130 generates an update response for the update request 301 based on a difference between the first sequence version information 3011 and second sequence version information 3021 corresponding to the second interaction sequence of a predetermined type at the server 130. It should be noted that two update responses are shown in FIG. 3, namely an update response 302-1 and an update response 302-2, and the update response 302-1 and the update response 302-2 may be collectively or individually referred to as update response(s) 302.

As an example, the transmission of the update request 301 and the update response 302 between the client 120 and the server 130) may be implemented depending on the corresponding transmission interface. For example, the transmission interface herein includes, but is not limited to, an application programming interface (API), and/or the like. The second interaction sequence is used to store and maintain interaction messages of a predetermined type initiated by the user 110 in the target live streaming. For example, according to different live streaming requirements and settings of the user 110, the server 130 may arrange the interaction messages in the second interaction sequence according to corresponding rules to identify an interaction message that should be presented currently and a respective presentation order of each next interaction message. For example, the server 130 may arrange the interaction messages in the second interaction sequence according to an interaction message initiation time of the interaction message of the predetermined type. In addition, the server 130 may further arrange the interaction message initiated by the initiator to a more forward position based on a user type of the initiator of the interaction message of the predetermined type or an additional operation used by the initiator, so that the interaction message can be presented earlier. After the presentation is complete, the interaction message that has been presented may be deleted from the second interaction sequence.

As an example, the second sequence version information 3021 may be an identifier about a current state of the second interaction sequence. The second sequence version information 3021 may be a number, a timestamp, a hash value, or any other information capable of uniquely identifying the current version of the interaction sequence.

In some embodiments, the update response 302 may include indication information for indicating whether the client 120 updates the local first interaction sequence. As an example, if the server 130 determines that the first sequence version information 3011 is different from the second sequence version information 3021, the server 130 may generate first indication information; if the server 130 determines that the first sequence version information 3011 is the same as the second sequence version information 3021, the server 130 may generate second indication information. The client 120 may determine that the first interaction sequence 202 needs to be updated in response to receiving the first indication information; and determine that the first interaction sequence 202 is unneeded to be updated in response to receiving the second indication information.

In other embodiments, the update response 302 may include the second sequence version information 3021. The client 120 may independently determine whether the first interaction sequence 202 is to be updated based on the second sequence version information 3021. Next, this process will be described in detail in the present disclosure.

In some embodiments, the server 130) generates the update response 302-1 based on at least the second sequence version information 3021 in accordance with a determination that the second sequence version information 3021 is the same as the first sequence version information 3011. In accordance with a determination that the second sequence version information 3021 is different from the first sequence version information 3011, the server 130 generates an update response 302-2 based at least on the second sequence version information 3021 and a message content 3022 and presentation time information 3023 of the at least one interaction message of the predetermined type.

As an example, if the second sequence version information 3021 is the same as the first sequence version information 3011, it is indicated that the interaction message in the current first interaction sequence 202 of the client 120 is consistent with the interaction message in the second interaction sequence. As an example, the consistency herein may refer to the consistency of the orders of the interaction messages, the presentation start time of each interaction message, and/or the presentation duration of each interaction message. In this case, the server 130 may generate the update response 302-1 only based on the second sequence version information 3021. Such an update response 302-1 may indicate that the state of the first interaction sequence 202 currently held by the client 120 is consistent with that of the server 130, and no new update needs to be applied.

In addition, for the second interaction sequence maintained at the server 130, when a new interaction message of a predetermined type is received or an editing instruction for an existing interaction message of a predetermined type is received, the server 130 updates the second interaction sequence while updating the second sequence version information 3021. In some embodiments, the server 130 updates the second sequence version information 3021 corresponding to the second interaction sequence in response to detecting that the second interaction sequence changes.

As an example, the server 130 may determine that the second interaction sequence changes in response to detecting such an operation as addition, deletion, modification, or the like for the second interaction sequence. Alternatively, the second sequence version information 3021 may be an incremental integer sequence (for example, 1.0, 1.1, 1.2, . . . ), which is increased by 1 after each update (for example, receiving a new interaction message or modifying an existing interaction message); or the second sequence version information 3021 is a timestamp based character string, and the character string represents a last update time of the second sequence version information 3021.

By updating the second sequence version information 3021 in real time, the server 130 can ensure that all the clients 120 can acquire the latest and consistent data state when obtaining the update response 302. This helps to avoid data collisions, errors, or omissions, thereby improving experiences of the user 110 and system reliability.

As an example, if the second sequence version information 3021 is different from the first sequence version information 3011, it is indicated that the interaction message in the current first interaction sequence 202 of the client 120 is inconsistent with the interaction message in the second interaction sequence. As an example, the inconsistency here may refer to the inconsistency of at least one of the orders of the interaction messages, the presentation start time of each interaction message, or the presentation duration of each interaction message. This usually involves the case where an interaction message is added, modified or deleted in the second interaction sequence since the client 120 last initiated the update request 301. In this case, the server 130 generates the update response 302-2 based on the second sequence version information 3021, the message content 3022 of the at least one interaction message of the predetermined type, and the presentation time information 3023. Such an update response 302-2 may indicate that the state of the first interaction sequence 202 currently held by the client 120 is inconsistent with that of the second interaction sequence at the server 130, and the update response 302-2 contains necessary information that the client 120 needs to update its first interaction sequence 202, such as a message content and presentation time information of a newly added interaction message and presentation time information of a message content of a modified interaction message.

As an example, the update response 302 may also indicate more content, which may be specifically determined according to actual needs. For example, the update response 302 may further indicate time information 303 of the interaction message of the predetermined type currently presented by the server. The time information 303 may include a presentation start time and/or presentation duration of the interaction message of the predetermined type currently presented by the server.

In this way, the consistency and real-time performance of data related to an interaction message of a predetermined type between the client 120 and the server 130 may be ensured, and at the same time, when data inconsistency occurs, the server 130 can return necessary information for updating.

In some embodiments, the update request 301 also indicates a reference time 3012, and the reference time 3012 is determined based on a presentation start time of the interaction message currently presented in the first interaction sequence 202. Herein, the at least one interaction message of the predetermined type is determined by the server 130 as follows: the server 130 extracts, from the second interaction sequence, an interaction message with a presentation start time later than the reference time 3012, to obtain at least one interaction message of a predetermined type. In addition, the server 130 may further extract, from the second interaction sequence, an interaction message with a presentation start time equal to the reference time 3012, to obtain at least one interaction message of a predetermined type.

As an example, before sending the update request 301, the client 120 determines an interaction message of the predetermined type which is currently presented in the live streaming interface 201, and a presentation start time of the interaction message. The client 120 may determine the presentation start time of the interaction message as the reference time 3012.

As an example, the server 130 may traverse the second interaction sequence, and search for all interaction messages each with a presentation start time later than the reference time 3012. These interaction messages are selected as the interaction message of the predetermined type and included in the subsequent update response 302 to be sent to the client 120.

According to this reference time 3012, the server 130 can find, from the second interaction sequence, the extraction time point corresponding to the interaction message currently presented by the client 120. Further, the server 130) can extract all interaction messages after the extraction time point (which may also be understood as a time point where the first interaction sequence 202 conflicts with the second interaction sequence) for updating the first interaction sequence 202 at the client 120. This mechanism causes the server 130 unneeded to send the entire second interaction sequence to the client 120, thereby reducing the overhead of data transmission and improving the efficiency of the update process. In addition, this mechanism can also ensure that the client 120 can receive all necessary interaction messages to update the first interaction sequence 202.

In some embodiments, the presentation time information of the at least one interaction message comprises at least one of: a presentation start time of the at least one interaction message; or a presentation duration of the at least one interaction message.

As an example, the presentation start time may refer to a specific moment at which the interaction message starts to be presented in the live streaming interface 201. The presentation start time determines when the interaction message is presented to the user 110, thereby ensuring that the interaction message of the predetermined type viewed by each user 110 in the target live streaming is the same.

As an example, the presentation duration may be a duration in which the interaction message is presented in the live streaming interface 201. The presentation duration may be fixed (for example, each interaction message is displayed for 5 seconds) or may be dynamically calculated.

Once the generation of the update response 302 is complete, the server 130 sends the update response 302 to the client 120. The client 120 receives the update response 302 for the update request 301 from the server 130. The client 120 then determines whether the first interaction sequence 202 is to be updated based on the update response 302.

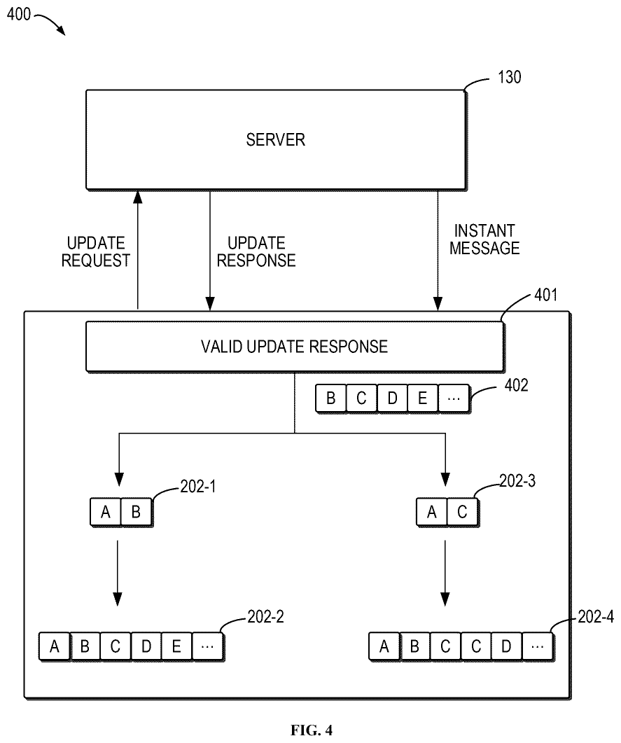

FIG. 4 illustrates a schematic diagram of an example 400 of updating a first interaction sequence according to some embodiments of the present disclosure. With reference to FIG. 3 and FIG. 4, due to such factors as network delay and processing speed difference, the update request 301 and the update response 302 may arrive at the client 120 and the server 130 in different orders. Based on this, in some embodiments, the client 120 determines that the update response 302 is a valid update response 401 for the update request 301 in response to detecting that the update response 302 includes the request version information 3013. The client 120 then determines whether the first interaction sequence 202 is to be updated based on the valid update response 401.

As an example, request version information 3013 is information, which is attached by the client 120 when sending the update request 301, for identifying the uniqueness of a request. The request version information 3013 may also sometimes be referred to as a request sequence number or a polling sequence number. As an example, after receiving the update request 301 and generating the corresponding update response 302, the server 130 may include the request version information 3013 attached to the update request 301 in the update response 302 and return the update response 302 to the client 120. The client 120 compares the request version information 3013 in the update response 302 with the request version information 3013 in the previously sent update request 301. If these two match (e.g., they are consistent), it is indicated that the update response 302 is an update response 302 for the update request 301. At this time, the client 120 may consider the update response 302 as the valid update response 401. If the two fail to match, it is indicated that the update response 302 is an update response 302 for the previous update request 301. At this time, the client 120 may consider that the update response 302 is an invalid update response, thereby avoiding erroneously updating the first interaction sequence 202.

In this way, the request version information 3013 helps the client 120 accurately detect the valid update response 401, thereby ensuring accuracy and consistency of data. Especially in an asynchronous and out-of-order case, the use of the request version information 3013 provides a powerful guarantee for the filtering out of the valid update response 401.

In some embodiments, the client 120 determines that the first interaction sequence 202 is unneeded to be updated in accordance with a determination that the second sequence version information 3021 is the same as the first sequence version information 3011. In accordance with a determination that the second sequence version information 3021 is different from the first sequence version information 3011, the client 120 determines that the first interaction sequence 202 needs to be updated. As an example, in a case that it is determined that the first interaction sequence 202 needs to be updated, the client 120 extracts the message content 3022 and the presentation time information 3023 of the at least one interaction message 402 of the predetermined type from the update response 302. For example, the at least one interaction message 402 may be, for example, interaction messages B. C. D. E shown in FIG. 4, and the like. The client 120 then updates the first interaction sequence 202 based on the extracted message content 3022 and the presentation time information 3023.

As an example, at the client 120, if the second sequence version information 3021 is the same as the first sequence version information 3011, it is indicated that the second interaction sequence at the server 130 does not change after the client 120 sends the last update request 301. Thus, the client 120 may determine that its first interaction sequence 202 is up-to-date without updating. On the contrary, if the second sequence version information 3021 is different from the first sequence version information 3011, it is indicated that the second interaction sequence at the server 130 has been updated. At this time, the client 120 needs to update its first interaction sequence 202 to ensure consistency with the second interaction sequence at the server 130.

In some embodiments, in accordance with a determination that each interaction message in the first interaction sequence 202 (for example, the interaction sequence 202-1 shown in FIG. 4) matches the presentation time information of the at least one interaction message 402, the client 120 adds the at least one interaction message 402 to the end of the first interaction sequence 202, to obtain the updated first interaction sequence 202 (for example, the interaction sequence 202-2 shown in FIG. 4).

As an example, in a case that it is determined that the first interaction sequence 202 is to be updated, the client 120 may check the presentation start time (and/or the presentation duration) of each interaction message in the first interaction sequence 202. Next, the client 120 compares whether the presentation start time (and/or presentation duration) of the interaction message in the first interaction sequence 202 matches the presentation start time (and/or presentation duration) of the at least one interaction message 402. As an example, “match” herein may mean that the presentation start time (and/or presentation duration) of a certain interaction message in the first interaction sequence 202 (for example, the interaction sequence 202-1 or the interaction sequence 202-3) is consistent with the presentation start time (and/or presentation duration) of the same interaction message in the at least one interaction message 402.

If it is determined that the interaction message in the first interaction sequence 202 matches the interaction message in the at least one interaction message 402 in terms of the presentation time (and/or the presentation duration), that is, the presentation time of the interaction message in the at least one interaction message 402 does not overlap with the existing interaction message in the first interaction sequence 202 or not occur in an unreasonable location, the client 120 maintains the ordering of the existing interaction messages in the first interaction sequence 202, and simultaneously arranges the at least one interaction message 402 according to its presentation start time, after the existing interaction messages in the first interaction sequence 202, to obtain the updated first interaction sequence 202.

In this way, the client 120 checks and avoids in the foregoing manner the conflict of the newly added interaction message and the existing interaction message in terms of the presentation time (and/or the presentation duration), and the client 120 can ensure that the interaction message viewed by the user 110 is presented in a correct chronological order.

In some embodiments, in accordance with a determination that the interaction message (for example, the interaction message C in the interaction sequence 202-3) in the first interaction sequence 202 fails to match the presentation time information in the at least one interaction message 402 (for example, the interaction message B in the at least one interaction message 402), the client 120 recorders the at least one interaction message 402 and the interaction message in the first interaction sequence 202 based on the presentation time information of the at least one interaction message 402, to obtain the updated first interaction sequence 202 (for example, the interaction sequence 202-4).

As an example, during the reordering process, the client 120 may arrange all interaction messages (for example, the interaction message in the interaction sequence 202-3 and the interaction message in the at least one interaction message 402) in the order of their presentation time information based on the presentation time information of the at least one interaction message 402. During the arrangement process, the client 120 ensures that each interaction message is located at its correct presentation time position to eliminate any time conflict.

Referring to FIG. 4, there is an interaction message B before an interaction message (for example, the interaction message C) in the at least one interaction message 402, and there is no interaction message B before the same interaction message (for example, the interaction message C) in the interaction sequence 202-3. Then, the client 120 may complete the reordering by inserting the interaction message B before the interaction message C and postponing the presentation start time of the interaction message B. Once the reordering is completed, the client 120 can obtain the updated first interaction sequence 202.

Through this reordering process, the client 120 can solve the issue that interaction sequences are inconsistent due to time conflicts.

In some embodiments, the first sequence version information 3011 corresponding to the updated first interaction sequence 202 is updated based on the second sequence version information 3021, so that the two are consistent.

As an example, the first sequence version information 3011 may be an incremental integer sequence (e.g., 1.0, 1.1, 1.2, . . . ), which is increased by 1 after each update; or the first sequence version information 3011 is a timestamp based character string, and the character string represents a last update time of the first sequence version information 3011.

In some embodiments, for the client 120 newly joining the target live streaming, the first interaction sequence 202 may be an empty sequence, that is, there is no interaction message in the first interaction sequence 202. In this case, the client 120 may directly update the first interaction sequence 202 by using the interaction message indicated by the interaction message information 3022 without performing the above-mentioned operation related to the conflict.

Specifically, in accordance with a determination that the first interaction sequence 202 is an empty sequence, the client 120 adds the at least one interaction message 402 to the first interaction sequence 202, to obtain the updated first interaction sequence 202. In accordance with a determination that the first interaction sequence 202 is a non-empty sequence, the client 120 determines in the manner described above whether the presentation time information of each interaction message in the first interaction sequence 202 fails to match the presentation time information of the at least one interaction message 402.

As an example, when the first interaction sequence 202 is an empty sequence, since there is no interaction message in the first interaction sequence 202, the client 120 may store the interaction message in the first interaction sequence 202 based on the arrangement order of the interaction message indicated by interaction message information 3022.

In this way, the client 120 newly joining the target live streaming can efficiently process the update of the first interaction sequence 202, so that the client 120 can quickly present corresponding content.

After determining whether the first interaction sequence 202 is to be updated, the client 120 presents an interaction message of a predetermined type in the live streaming interface 201 based on a result of a determination of the update for the first interaction sequence 202.

In some embodiments, in accordance with a determination that the first interaction sequence 202 is to be updated, the client 120 sequentially presents the updated interaction message in the first interaction sequence in the live streaming interface 201 based on the presentation start time and the presentation duration of each interaction message in the updated first interaction sequence. In accordance with a determination that the first interaction sequence 202 is unneeded to be updated, the client 120 sequentially presents the interaction message in the current first interaction sequence in the live streaming interface 201 based on the presentation start time and the presentation duration of each interaction message in the current first interaction sequence.

As an example, for each interaction message in the interaction messages of a predetermined type, the presentation start time determines when the interaction message starts to be presented in the live streaming interface 201, and the presentation duration determines how long the interaction message needs to be presented. The client 120 ensures that these interaction messages of the predetermined type are properly displayed to the user 110 at the corresponding presentation start time.

As an example, within one period, the client 120 only presents one of the interaction messages of the predetermined type at a time. When the next interaction message in interaction messages of the predetermined type is to be presented, the client 120 may cover the currently presented interaction message with the next interaction message.

In this way, the client 120 can ensure that the interaction messages of the predetermined type viewed by the individual users 110 in the target live streaming are consistent, and can also maintain the cleanliness of the live streaming interface 201 and the readability of the interaction message of the predetermined type.

In some embodiments, for a first interaction message currently being presented and a second interaction message to be presented next, among the interaction messages of the predetermined type, the client 120 extends a time interval between the presentation start time of the second interaction message and the presentation start time of the first interaction message, in accordance with a determination that the presentation start time of the second interaction message is earlier than the predicted presentation start time of the second interaction message. In addition, in accordance with a determination that the presentation start time of the second interaction message is later than the predicted presentation start time of the second interaction message, the client 120 shortens the time interval between the presentation start time of the second interaction message and the presentation start time of the first interaction message by adjusting a buffer time corresponding to the second interaction message.

As an example, for each interaction message of a predetermined type, the client 120 may determine its predicted presentation start time according to a certain algorithm or rule. The predicted presentation start time may be calculated by the client 120 based on various factors such as the position of the interaction message in the first interaction sequence 202, the presentation duration of each interaction sequence in the first interaction sequence 202, and the local time of the client 120.

As an example, in a case where the second interaction message is ready to be presented, the client 120 compares its set presentation start time with the predicted presentation start time. This comparison is to determine whether the second interaction message can be presented at its set presentation start time.

If the client 120 determines that the presentation start time of the second interaction message is earlier than the predicted presentation start time, it is indicated that the second interaction message may occur too early. In order to solve this issue, the client 120 extends the time interval between the presentation start time of the second interaction message and the presentation start time of the first interaction message by adjusting the buffer time corresponding to the second interaction message (that is, a waiting presentation time for the interaction message before its presentation starts). In this way, the second interaction message will appear at a more suitable time point without interfering with a viewing experience of the user 110.

Conversely; if the client 120 determines that the presentation start time of the second interaction message is later than the predicted presentation start time, it is indicated that the second interaction message may occur too late. In this case, the client 120 also shortens the time interval between the presentation start time of the second interaction message and the presentation start time of the first interaction message by adjusting the buffer time, to ensure that the second interaction message can be presented to the user 110 in time.

In some embodiments, for a third interaction message currently presented in the live streaming interface 201, among the interaction messages of the predetermined type, the client 120 determines, in response to receiving a second instant message from the server 130, additional information related to a presentation style of the third interaction message from the second instant message. Then, the client 120 updates the presentation style of the third interaction message in the live streaming interface 201 based on the additional information of the third interaction message.

Instant Messaging (IM) may be a technical means for implementing real-time communication over a network, which allows participating devices to exchange instant information in various forms such as text, voice, video, picture and the like. This communication mode has high instantaneity and interactivity.

As an example, the second instant message may be delivered by the server 130 after a change in the second interaction sequence is detected, or may be periodically delivered by the server 130. The additional information may refer to additional data associated with main information (which may here refer to a message content and presentation time information and/or the like of the third interaction message). For example, the additional information may include a color code, a font name and size, a background image or color, animation effect parameters, and the like. The additional information is typically generated by the server 130 and sent to the client 120 as part of the instant message.

As an example, in the live streaming interface 201, the third interaction message may be presented according to the necessary content indicated by its main information. Based on the extracted additional information, the client 120 may update the presentation style of the third interaction message in real time in the live streaming interface 201. This may involve changing a text color, a font, a background image, or an animation effect, and/or the like. The updated third interaction message is displayed in the live streaming interface 201 in a new presentation style, so that the user 110 can view these changes in time.

In the foregoing manner, the client 120 may actively update the locally maintained first interaction sequence 202 based on polling manner, so that the first interaction sequence 202 is synchronized with the second interaction sequence at the server, thereby ensuring that the user 110 associated with the client 120 can accurately view an interaction message of a predetermined type in the live streaming in time. In addition, in order to save resource overheads of the client 120, the client 120 may selectively update the first interaction sequence 202 in the foregoing manner based on a user type of the user 110 associated with the client 120.

Specifically, the client 120 sends an update request 301 for the first interaction sequence 202 to the server 130 in accordance with a determination that the user 110 associated with the client 120 corresponds to a predetermined user type. In some embodiments, the client 120 updates the first interaction sequence 202 based on a first instant message received from the server 130 in accordance with a determination that the user 110 associated with the client 120 corresponds to a non-predetermined user type, where the first instant message at least indicates a newly added or updated interaction message of the predetermined type at the server 130.

As an example, the user 110 associated with the client 120 may be the user 110 associated with the live streaming interface 201 currently presented by the client 120. For example, the user 110 associated with the client 120 may refer to the user who has established a connection with the client 120 in some manner (e.g., login, verification, and/or the like), enabling the client 120 to detect and perform corresponding operations. The predetermined user type may refer to one or more specific user roles or specific permission levels defined in the target live streaming.

In this way, the client 120 can determine, according to the type of the user 110, whether the first interaction sequence 202 is to be updated by sending the update request 301, and for the user 110 corresponding to the non-predetermined user type, the client 120 can update the first interaction sequence 202 according to the first instant message sent by the server 130 without frequently sending the polling request. This reduces the consumption of a network bandwidth and the resource consumption of the client 120 by synchronizing a particular type of interaction sequences according to different user types.

As an example, the first instant message may be sent by the server 130 to the client 120 in response to a change of the second interaction sequence or through a timed task (e.g., which may be set once every 2 seconds). As an example, the message play time of the first instant message may be determined according to actual needs (for example, 8 seconds). Correspondingly, the number of repetitions of sending of the first instant message may also be determined according to actual needs (for example, 3 times). Therefore, the influence of an instant message loss caused by a poor network environment can be reduced.

FIG. 5 illustrates a schematic diagram of an example 500 of a first instant message according to some embodiments of the present disclosure. Referring to FIG. 5, as an example, the first instant message may indicate a presentation content 5011, a presentation start time 5012, a presentation duration 5013 of the interaction message 501 currently presented by the server 130, one or more interaction messages 502 of a predetermined type presented after the interaction message, and presentation contents 5011, presentation start time 5012, and presentation durations 5013 of these interaction messages 502. In addition, according to actual needs, the first instant message may further indicate more content such as second sequence version information 3021 and additional information of each message, which is not limited in the embodiments of the present disclosure.

As an example, after receiving the interaction messages indicated by the first instant message, the client 120 may determine whether the interaction messages fail to match the existing interaction message in the first interaction sequence 202 based on the presentation start time and the presentation durations of these interaction messages, and one or more interaction messages of predetermined types presented after the interaction message. In the case of matching, the client 120 may add the interaction message indicated by the first instant message to the end of the first interaction sequence 202 to update the first interaction sequence 202. In the case of failing to match, using the interaction message indicated by the first instant message as a benchmark, the client 120 may reorder the interaction messages indicated by the first instant message and the interaction message in the first interaction sequence 202, to obtain the updated first interaction sequence 202.

In some embodiments, whether the user 110) associated with the client 120 corresponds to a predetermined user type is determined by at least one of: determining that the user 110 associated with the client 120 corresponds to the predetermined user type in accordance with a determination that the user 110 associated with the client 120 in the live streaming interface 201 is a streamer. Alternatively, the client 120 determines that the user 110) associated with the client 120 corresponds to the predetermined user type in accordance with a determination that the user 110 associated with the client 120 has sent an interaction message of a predetermined type and the duration in which the interaction message is not presented or is presented in the live streaming interface 201 is less than a predetermined duration.

As an example, if the client 120 determines that the user 110 associated with the client 120 is the streamer of the target live streaming, it may be determined that the user 110 corresponds to a predetermined user type. Therefore, the client 120 of the streamer can obtain the latest first interaction queue in the above-mentioned polling manner, to ensure that the presentation of the interaction message in the live streaming room is kept highly synchronized with the server 130.

As an example, the client 120 may determine whether the user 110 currently associated with the client 120) has sent an interaction message of a predetermined type, and check the presence status of the interaction message of the predetermined type in the live streaming interface 201. If the presentation of the interaction message is not completed (i.e., the interaction message is still queued to display; or is being displayed but has not yet ended), the user 110 is deemed to correspond to the predetermined user type. If the user 110 associated with the client 120 sends an interaction message of a predetermined type and the presentation of the interaction message is not completed, the client 120 regards the user 110 as an “interaction audience”, so that the client 120 can obtain the latest first interaction queue through the above-mentioned polling manner, to ensure that the presentation of the interaction message in the live streaming room is kept highly synchronized with the server 130.

As an example, in a case where the presentations of all interaction messages of the predetermined type sent by the “interaction audience” are complete, the client 120 determines that the user 110 corresponds to a non-predetermined user type, and thus updates the first interaction queue by waiting for the first instant message issued by the server 130, thereby reducing network occupation and resource usage of the client 120.

In this way, the embodiments of the present disclosure enable the client 120 to update the first interaction sequence 202 in two different manners based on the user type of the user 110, thereby minimizing the overhead of the client 120 on the basis of ensuring that a specific user 110 can view the interaction message of the predetermined type accurately and in real time.

In addition, in some embodiments, for each interaction message in the second interaction sequence, when each interaction message is added to the second interaction sequence, the server 130 may determine the presentation start time of the interaction message in the following manner.

In some embodiments, for a newly added or updated fourth interaction message in the second interaction sequence, the server 130 determines a presentation start time of the fourth interaction message, based on a reference buffer time corresponding to the fourth interaction message, and a presentation start time and a presentation duration of a fifth interaction message located before the fourth interaction message in the second interaction sequence.

As an example, the reference buffer time is used to account for effects induced by such an event as network delay; differences of processing speeds of clients 120, and the like. The reference buffer time may be a fixed value, but may also be adjusted according to actual conditions in some cases.

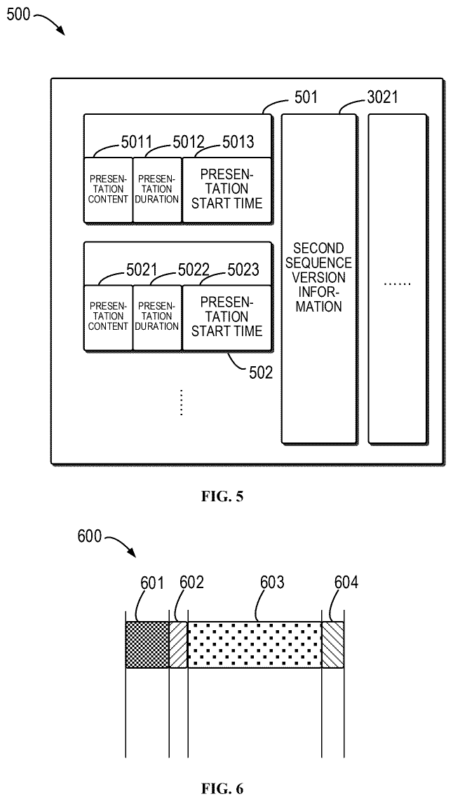

FIG. 6 illustrates a schematic diagram of an example 600 of an interaction message in a second interaction sequence at a server according to some embodiments of the present disclosure. Referring to FIG. 6, as an example, the information structure corresponding to the fourth interaction message (or the fifth interaction message) comprises at least four parts: a buffer time 601 (buffer), an interaction message presentation animation time 602 (fade-in), an interaction message body 603, and an interaction message disappearance animation time 604 (fade-out). As described above, the buffer time 601 is used to be adjusted by the client 120 to shorten the time interval between two adjacent interaction messages. The reference buffer time may be an initial setting value of the buffer time 601, which may be specifically determined according to actual needs, which is not limited in the embodiments of the present disclosure. As an example, the interaction message presentation animation time 602 is the time required from an initial appearance to a full presentation of the interaction message. The interaction message body 603 has a presentation start time and a presentation duration, and the presentation duration is set according to the content and form of the message. The interaction message disappearance animation time 604 may take a fixed length (e.g., 0.5 seconds), which represents the time required from the end of a presentation to a complete disappearance of the interaction message.

Based on the definitions of these parts, the server 130 may calculate the presentation start time Msg[N].StartTime of the fourth interaction message by using Equation 1:

$$Msg [ N ] . StartTime = \{ Msg [ N - 1 ] . StartTime + Msg [ N - 1 ] . Duration + X ; \qquad Equation 1$$

As an example, Msg[N−1]. StartTime is a presentation start time of the fifth interaction message. Msg[N−1].Duration is a presentation duration of the fifth interaction message, and X is an interval between the fourth interaction message and the fifth interaction message (for example, a sum of the interaction message disappearance animation time 604 of the fifth interaction message, the buffering time 601 of the fourth interaction message, and the interaction message disappearance animation time 604 of the fourth interaction message).

As an example, if the fourth interaction message is the first interaction message in the second interaction sequence, its presentation start time may be set by the server 130 according to the actual situations and needs of the live streaming.

It is considered that the target live streaming may involve participation of the users 110 across regions. Therefore, the data related to the target live streaming may be respectively managed by different servers 130. In this case, the embodiment of the present disclosure uses the server 130 of a key user 110 of the users 110 as a central server 130, and synchronizes the second interaction sequence to other servers 130 through a synchronization strategy.

Specifically, in response to detecting that the second interaction sequence changes, the server 130 synchronizes the changed second interaction sequence to the server 130 associated with at least one live streaming participant in the target live streaming.

As an example, the server 130 may determine that the second interaction sequence changes in response to detecting such an operation as addition, deletion, modification, or the like for the second interaction sequence. As an example, in the embodiments of the present disclosure, the server 130 associated with the streamer of the target live streaming serves as the central server 130, and after the second interaction sequence at the server 130) changes, the server 130 initiates synchronization for the second interaction sequence to other servers 130 by using an appropriate distributed service invocation protocol (for example, des-rpc). As an example, to ensure that the second interaction sequences of other reference servers 130 are consistent with the second interaction sequence of the central server 130, other servers 130 may perform synchronization by using an appropriate distributed cache coordination service (for example, decc).

### Example Processes

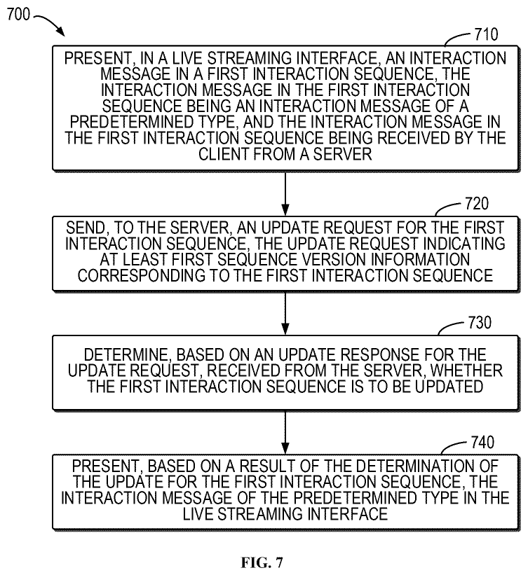

FIG. 7 illustrates a flowchart of an example process 700 of a method of presenting an interaction message at a client side according to some embodiments of the present disclosure. The process 700 may be implemented at client 120.

Referring to FIG. 7, at block 710, the client 120 presents an interaction message in a first interaction sequence 202 in a live streaming interface 201, the interaction message in the first interaction sequence 202 is an interaction message of a predetermined type, and the interaction message in the first interaction sequence is received by the client 120 from a server 130.

At block 720, the client 120 sends an update request 301 for the first interaction sequence 202 to the server 130, and the update request 301 indicates at least first sequence version information 3011 corresponding to the first interaction sequence 202.

In some embodiments, the client 120 sends an update request 301 for the first interaction sequence 202 to the server 130 in accordance with a determination that a user associated with the client 120 corresponds to a predetermined user type.

In some embodiments, it is determined whether the user associated with the client 120 corresponds to the predetermined user type, by at least one of the following. In one example, the client 120 determines that the user associated with the client 120 corresponds to the predetermined user type, in accordance with a determination that the user associated with the client 120 in the live streaming interface 201 is a streamer user. In another example, the client 120 determines that the user associated with the client 120 corresponds to the predetermined user type, in accordance with a determination that the user associated with the client 120 has sent the interaction message of the predetermined type and a duration in which the interaction message is unpresented or presented in the live streaming interface 201 is less than a predetermined duration.

At block 730, the client 120 determines whether the first interaction sequence 202 is to be updated based on an update response 302 for the update request 301 received from the server 130.

In some embodiments, the client 120 determines that the update response 302 is a valid update response 401 for the update request 301, in response to detecting that the update response 302 includes the request version information 3013; and determines whether the first interaction sequence 202 is to be updated based on the valid update response 401.

In some embodiments, the update response 302 indicates at least second sequence version information 3021 of a second interaction sequence of the predetermined type at the server 130. The client 120 determines that the first interaction sequence 202 is unneeded to be updated in accordance with a determination that the second sequence version information 3021 is the same as the first sequence version information 3011; and in accordance with a determination that the second sequence version information 3021 is different from the first sequence version information 3011, the client 120 extracts a message content 3022 and presentation time information 3023 of at least one interaction message of the predetermined type from the update response 302, and updates the first interaction sequence 202 based on the extracted message content 3022 and the presentation time information 3023.

In some embodiments, the presentation time information of the at least one interaction message 402 comprises at least one of: a presentation start time of the at least one interaction message 402; or a presentation duration of the at least one interaction message 402.

In some embodiments, the update request 301 further indicates a reference time 3012, where the reference time 3012 is determined based on a presentation start time of an interaction message that is currently presented in the first interaction sequence 202; and where the at least one interaction message 402 includes an interaction message with a presentation start time later than the reference time 3012, in the second interaction sequence.

In some embodiments, the at least one interaction message 402 is added to the first interaction sequence 202 to obtain the updated first interaction sequence 202, in accordance with a determination that the first interaction sequence 202 is an empty sequence; and it is determined whether each interaction message in the first interaction sequence 202 matches the presentation time information of the at least one interaction message 402, in accordance with a determination that the first interaction sequence 202 is a non-empty sequence.

In some embodiments, the at least one interaction message 402 is added to an end of the first interaction sequence 202 to obtain the updated first interaction sequence 202, in accordance with a determination that each interaction message in the first interaction sequence 202 matches the presentation time information of the at least one interaction message 402.

In some embodiments, the at least one interaction message 402 of the predetermined type and an interaction message in the first interaction sequence 202 are reordered to obtain the updated first interaction sequence 202 based on the presentation time information of the at least one interaction message 402 of the predetermined type, in accordance with a determination that the interaction message 402 in the first interaction sequence 202 fails to match with the presentation time information of the at least one interaction message.

In some embodiments, the first sequence version information 3011 corresponding to the updated first interaction sequence 202 is updated based on the second sequence version information 3021.

At block 740, the client 120 presents the interaction message of the predetermined type in the live streaming interface 201 based on a result of the determination of the update for the first interaction sequence 202.

In some embodiments, each interaction message in the updated first interaction sequence is sequentially presented in the live streaming interface 201 based on a presentation start time and a presentation duration of the interaction message in the updated first interaction sequence, in accordance with a determination that the first interaction sequence 202 is to be updated; each interaction message in the current first interaction sequence is sequentially presented in the live streaming interface 201 based on a presentation start time and a presentation duration of the interaction message in the current first interaction sequence, in accordance with a determination that the first interaction sequence 202 is unneeded to be updated.

In some embodiments, for a first interaction message currently being presented and a second interaction message to be presented next, among the interaction messages of the predetermined type, a time interval between a presentation start time of the second interaction message and a presentation start time of the first interaction message is extended by adjusting a buffer time corresponding to the second interaction message, in accordance with a determination that the presentation start time of the second interaction message is earlier than a predicted presentation start time of the second interaction message; and a time interval between the presentation start time of the second interaction message and the presentation start time of the first interaction message is shortened by adjusting the buffer time corresponding to the second interaction message, in accordance with a determination that the presentation start time of the second interaction message is later than the predicted presentation start time of the second interaction message.

In some embodiments, for a third interaction message currently presented in the live streaming interface 201, among the interaction messages of the predetermined type, additional information related to a presentation style of the third interaction message is determined from the second instant message in response to receiving a second instant message from the server 130; and the presentation style of the third interaction message is updated in the live streaming interface 201 based on the additional information of the third interaction message.

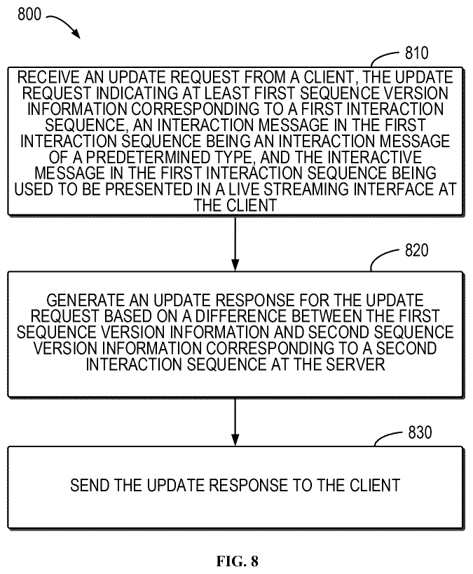

FIG. 8 illustrates a flowchart of an example process 800 of a method of presenting an interaction message at a side of a server 130 according to some embodiments of the present disclosure. The process 800 may be implemented at the server 130.

Referring to FIG. 8, at 810, the server 130 receives an update request 301 from the client 120, the update request 301 indicates at least first sequence version information 3011 corresponding to a first interaction sequence 202, an interaction message in the first interaction sequence 202 is an interaction message of a predetermined type, and the interaction message in the first interaction sequence 202 is used to be presented in the live streaming interface 201 at the client 120.

At block 820, the server 130) generates an update response 302 for the update request 301 based on a difference between the first sequence version information 3011 and second sequence version information 3021 corresponding to a second interaction sequence at the server 130.

In some embodiments, the update response 302 is generated based at least on the second sequence version information 3021, in accordance with a determination that the second sequence version information 3021 is the same as the first sequence version information 3011; and the update response 302 is generated based at least on the second sequence version information 3021 and a message content 3022 and presentation time information 3023 of at least one interaction message of the predetermined type, in accordance with a determination that the second sequence version information 3021 is different from the first sequence version information 3011.

In some embodiments, the presentation time information of the at least one interaction message 402 of the predetermined type comprises at least one of: a presentation start time of the at least one interaction message 402 of the predetermined type; or a presentation duration of the at least one interaction message 402 of the predetermined type.

In some embodiments, the update request 301 further indicates a reference time 3012, where the reference time 3012 is determined based on a presentation start time of an interaction message that is currently presented in the first interaction sequence 202; and where the at least one interaction message 402 of the predetermined type is determined by extracting, from the second interaction sequence, an interaction message with a presentation start time later than the reference time 3012 to obtain the at least one interaction message 402 of the predetermined type.

At block 830, the server 130 sends the update response 302 to the client 120.

In some embodiments, for the newly added or updated fourth interaction message in the second interaction sequence, a presentation start time of the fourth interaction message is determined based on a reference buffer time corresponding to the fourth interaction message, and a presentation start time and a presentation duration of a fifth interaction message located before the fourth interaction message in the second interaction sequence.

In some embodiments, the second sequence version information 3021 corresponding to the second interaction sequence is updated in response to detecting that the second interaction sequence is changed.

In some embodiments, the changed second interaction sequence is synchronized to a server 130) associated with the at least one live streaming participant in response to detecting that the second interaction sequence is changed.

### Example Apparatuses and Devices

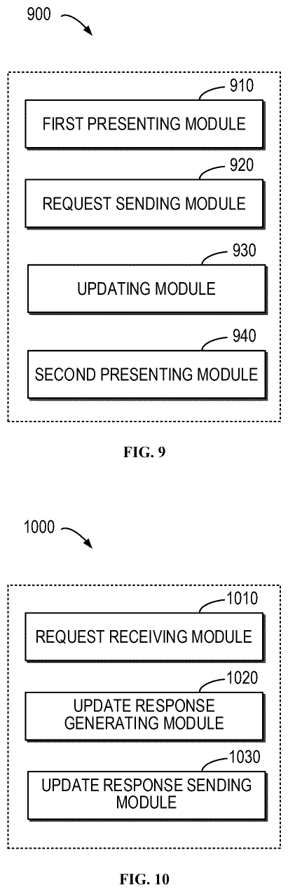

Embodiments of the present disclosure also provide corresponding apparatuses for implementing the above methods or processes. FIG. 9 illustrates a schematic structural block diagram of an apparatus 900 for presenting an interaction message according to some embodiments of the present disclosure. The apparatus 900 may be implemented or included in the client 120. The various modules/components in the apparatus 900 may be implemented by hardware, software, firmware, or any combination thereof.

Referring to FIG. 9, the apparatus 900 includes a first presenting module 910, a request sending module 920, an updating module 930, and a second presenting module 940. In some embodiments, the first presenting module 910 is configured to present, in a live streaming interface 201, an interaction message in a first interaction sequence 202, the interaction message in the first interaction sequence 202 being an interaction message of a predetermined type, and the interaction message in the first interaction sequence 202 being received by the client 120 from a server 130. The request sending module 920 is configured to send, to the server 130, an update request 301 for the first interaction sequence 202, the update request 301 indicating at least first sequence version information 3011 corresponding to the first interaction sequence 202. The updating module 930 is configured to determine, based on an update response 302 for the update request 301, received from the server, whether the first interaction sequence 202 is to be updated. The second presenting module 940 is configured to present, based on a result of the determination of the update for the first interaction sequence 202, the interaction message of the predetermined type in the live streaming interface 201.

In some embodiments, the update response 302 indicates at least second sequence version information 3021 of a second interaction sequence of the predetermined type at the server 130. The updating module 930 is further configured to: determine that the first interaction sequence 202 is unneeded to be updated, in accordance with a determination that the second sequence version information 3021 is the same as the first sequence version information 3011; or in accordance with a determination that the second sequence version information 3021 is different from the first sequence version information 3011, extract, from the update response 302, a message content 3022 and presentation time information 3023 of at least one interaction message of the predetermined type, and update the first interaction sequence 202 based on the extracted message content 3022 and presentation time information 3023.

In some embodiments, the update request 301 further indicates a reference time 3012, the reference time 3012 being determined based on a presentation start time of the interaction message that is currently presented in the first interaction sequence 202; and the at least one interaction message 402 includes an interaction message with a presentation start time later than the reference time 3012, in the second interaction sequence.

In some embodiments, the updating module 930 is further configured to: add the at least one interaction message 402 to an end of the first interaction sequence 202 to obtain the updated first interaction sequence 202, in accordance with a determination that each interaction message in the first interaction sequence 202 matches the presentation time information of the at least one interaction message 402.

In some embodiments, the updating module 930 is further configured to: reorder, based on the presentation time information of the at least one interaction message 402, the at least one interaction message 402 and an interaction message in the first interaction sequence 202 to obtain the updated first interaction sequence 202, in accordance with a determination that the interaction message in the first interaction sequence 202 fails to match with the presentation time information of the at least one interaction message 402.

In some embodiments, the updating module 930 is further configured to: add the at least one interaction message 402 of the predetermined type to the first interaction sequence 202 to obtain the updated first interaction sequence 202, in accordance with a determination that the first interaction sequence 202 is an empty sequence; and determine whether each interaction message in the first interaction sequence 202 matches the presentation time information of the at least one interaction message 402, in accordance with a determination that the first interaction sequence 202 is a non-empty sequence.

In some embodiments, the presentation time information of the at least one interaction message 402 comprises at least one of: a presentation start time of the at least one interaction message 402; or a presentation duration of the at least one interaction message 402.

In some embodiments, the apparatus 900 further includes a first version information updating module. The first version information updating module is configured to update the first sequence version information 3011 corresponding to the updated first interaction sequence 202 based on the second sequence version information 3021.

In some embodiments, the update request 301 comprises request version information 3013 of the update request 301; and the updating module 930 is further configured to: determine that the update response is a valid update response for the update request, in response to detecting that the update response includes the request version information; and determinine based on the valid update response, whether the first interaction sequence is to be updated.

In some embodiments, the apparatus 900 further includes a buffer time adjusting module. The buffer time adjusting module is configured to: for a first interaction message currently being presented and a second interaction message to be presented next, among the interaction messages of the predetermined type, extend a time interval between a presentation start time of the second interaction message and a presentation start time of the first interaction message by adjusting a buffer time corresponding to the second interaction message, in accordance with a determination that the presentation start time of the second interaction message is earlier than a predicted presentation start time of the second interaction message; and shorten a time interval between the presentation start time of the second interaction message and the presentation start time of the first interaction message by adjusting the buffer time corresponding to the second interaction message, in accordance with a determination that the presentation start time of the second interaction message is later than the predicted presentation start time of the second interaction message.

In some embodiments, the second presenting module 940 is further configured to: sequentially present, in the live streaming interface 201, each interaction message in the updated first interaction sequence, based on a presentation start time and a presentation duration of the interaction message in the updated first interaction sequence, in accordance with a determination that the first interaction sequence 202 is to be updated; and sequentially present, in the live streaming interface 201, each interaction message in the current first interaction sequence, based on a presentation start time and a presentation duration of the interaction message in the current first interaction sequence, in accordance with a determination that the first interaction sequence 202 is unneeded to be updated.

In some embodiments, the request sending module 920 is further configured to: send, to the server 130, the update request for the first interaction sequence 202, in accordance with a determination that a user associated with the client 120 corresponds to a predetermined user type.

In some embodiments, the request sending module 920 is further configured to: determine that the user associated with the client 120 corresponds to the predetermined user type, in accordance with a determination that the user associated with the client 120 in the live streaming interface 201 is a streamer user; or determine that the user associated with the client 120 corresponds to the predetermined user type, in accordance with a determination that the user associated with the client 120 has sent the interaction message of the predetermined type and a duration in which the interaction message is unpresented or presented in the live streaming interface 201 is less than a predetermined duration.

In some embodiments, the second presenting module 940 is further configured to: for a third interaction message currently presented in the live streaming interface 201, among the interaction messages of the predetermined type, determine, in response to receiving a second instant message from the server 130, from the second instant message, additional information related to a presentation style of the third interaction message; and update, based on the additional information of the third interaction message, the presentation style of the third interaction message in the live streaming interface 201.

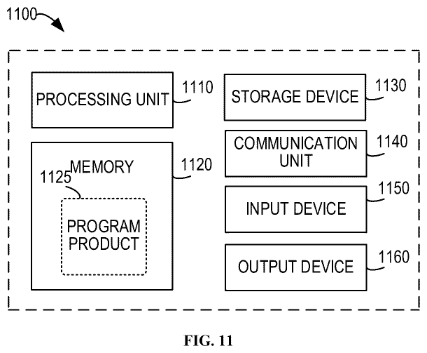

FIG. 10 illustrates a schematic structural block diagram of an apparatus 1000 for presenting an interaction message according to some embodiments of the present disclosure. The apparatus 1000 may be implemented or included in the server 130. The various modules/components in the apparatus 1000 may be implemented by hardware, software, firmware, or any combination thereof.

Referring to FIG. 10, the apparatus 1000 includes a request receiving module 1010, an update response generating module 1020, and an update response sending module 1030. In some embodiments, the request receiving module 1010 is configured to receive an update request 301 from the client 120, the update request 301 indicating at least first sequence version information 3011 corresponding to a first interaction sequence 202, an interaction message in the first interaction sequence 202 being an interaction message of a predetermined type, and the interaction message in the first interaction sequence 202 being used to be presented in a live streaming interface 201 at the client 120. The update response generating module 1020 is configured to generate an update response 302 for the update request 301 based on a difference between the first sequence version information 3011 and second sequence version information 3021 corresponding to a second interaction sequence at the server 130. The update response sending module 1030 is configured to send the update response 302 to the client 120.

In some embodiments, the update response generating module 1020 is further configured to: generate the update response 302 based at least on the second sequence version information 3021, in accordance with a determination that the second sequence version information 3021 is the same as the first sequence version information 3011; and generate the update response 302 based at least on the second sequence version information 3021 and a message content 3022 and presentation time information 3023 of at least one interaction message of the predetermined type, in accordance with a determination that the second sequence version information 3021 is different from the first sequence version information 3011.

In some embodiments, the update request 301 further indicates a reference time 3012, and the reference time 3012 is determined based on a presentation start time of an interaction message that is currently presented in the first interaction sequence 202; and the update response generating module 1020 is further configured to extract, from the second interaction sequence, an interaction message with a presentation start time later than the reference time 3012, to obtain the at least one interaction message 402.

In some embodiments, the presentation time information of the at least one interaction message 402 comprises at least one of: a presentation start time of the at least one interaction message 402; or a presentation duration of the at least one interaction message 402.

In some embodiments, the apparatus 1000 further includes a presentation start time determining module. The presentation start time determining module is configured to: for a newly added or updated fourth interaction message in the second interaction sequence, determine a presentation start time of the fourth interaction message based on a reference buffer time corresponding to the fourth interaction message, and a presentation start time and a presentation duration of a fifth interaction message located before the fourth interaction message in the second interaction sequence.

In some embodiments, the apparatus 1000 further includes a second sequence version updating module. The second sequence version updating module is configured to update, in response to detecting that the second interaction sequence is changed, the second sequence version information 3021 corresponding to the second interaction sequence.

In some embodiments, for the server 130 associated with a streamer, the apparatus 1000 further includes a synchronizing module. The synchronizing module is configured to: synchronize, in response to detecting that the second interaction sequence is changed, the changed second interaction sequence to a server 130) associated with at least one live streaming participant.

FIG. 11 illustrates a block diagram of an electronic device 1100 in which one or more embodiments of the present disclosure may be implemented. For example, the electronic device 1100 may be used to implement the client 120 and/or the server 130 shown in FIG. 1. It should be understood that the electronic device 1100 illustrated in FIG. 11 is merely for the purpose of example and should not constitute any limitation on the functionality and scope of the embodiments described herein.

Referring to FIG. 11, the electronic device 1100 is in the form of a general-purpose electronic device. Components of the electronic device 1100 may include, but are not limited to, one or more processors or processing units 1110, a memory 1120, a storage device 1130, one or more communication units 1140, one or more input devices 1150, and one or more output devices 1160. The processing unit 1110 may be a physical or virtual processor and capable of performing various processes according to programs stored in the memory 1120. In multiprocessor systems, multiple processing units execute computer-executable instructions in parallel to improve parallel processing capabilities of electronic device 1100.

Electronic device 1100 typically includes a plurality of computer storage media. Such media may be any available media accessible to the electronic device 1100, including, but not limited to, volatile and non-volatile media, removable and non-removable media. The memory 1120 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1130 may be a removable or non-removable medium and may include a machine-readable medium, such as a flash drive, magnetic disk, or any other medium, which may be capable of storing information and/or data and may be accessed within electronic device 1100.

The electronic device 1100 may further include additional removable/non-removable, volatile/non-volatile storage media. Although not shown in FIG. 11, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1120 may include a computer program product 1125 having one or more program modules configured to perform various methods or actions of various embodiments of the present disclosure.

The communication unit 1140 is configured to communicate with another electronic device through a communication medium. Additionally, the functionality of components of the electronic device 1100 may be implemented in a single computing cluster or multiple computing machines capable of communicating over a communication connection. Thus, the electronic device 1100 may operate in a networked environment using logical connections with one or more other servers, network personal computers (PCs), or another network node.

The input device 1150 may be one or more input devices such as a mouse, a keyboard, a trackball, or the like. The output device 1160 may be one or more output devices, such as a display, a speaker, a printer, or the like. The electronic device 1100 may also communicate with one or more external devices (not shown) through the communication unit 1140 as needed, external devices such as storage devices, display devices, and/or the like, communicate with one or more devices that enable a user to interact with the electronic device 1100, or communicate with any device (e.g., a network card, a modem, and/or the like) that enables the electronic device 1100 to communicate with one or more other electronic devices. Such communication may be performed via an input/output (I/O) interface (not shown).

According to example implementations of the present disclosure, there is provided a non-transitory computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a non-transitory computer-readable storage medium that cause the computer, programmable data processing apparatus, and/or other devices to function in a particular manner, such that the non-transitory computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are for the purpose of example, not exhaustive, and are not limited to the implementations disclosed. Many modifications and variations will be apparent to those of ordinary skill in the art without departing from the scope and spirit of the various implementations illustrated. Determination of the terms used herein is intended to best explain the principles of the implementations, practical applications, or improvements to techniques in the marketplace, or to enable others of ordinary skill in the art to understand the various implementations disclosed herein.

1. A method of presenting an interaction message, implemented at a client, the method comprising:
presenting, in a live streaming interface, an interaction message in a first interaction sequence, the interaction message in the first interaction sequence being an interaction message of a predetermined type, and the interaction message in the first interaction sequence being received by the client from a server;
sending, to the server, an update request for the first interaction sequence, the update request indicating at least first sequence version information corresponding to the first interaction sequence;
determining, based on an update response for the update request, received from the server, whether the first interaction sequence is to be updated; and
presenting, based on a result of the determination of the update for the first interaction sequence, the interaction message of the predetermined type in the live streaming interface.

2. The method of claim 1, wherein the update response indicates at least second sequence version information of a second interaction sequence of the predetermined type at the server; and
wherein determining, based on the update response, whether the first interaction sequence is to be updated comprises:
determining that the first interaction sequence is unneeded to be updated, in accordance with a determination that the second sequence version information is the same as the first sequence version information; or
in accordance with a determination that the second sequence version information is different from the first sequence version information,
extracting, from the update response, a message content and presentation time information of at least one interaction message of the predetermined type, and
updating the first interaction sequence based on the extracted message content and presentation time information.

3. The method of claim 2, wherein the update request further indicates a reference time, the reference time being determined based on a presentation start time of an interaction message that is currently presented in the first interaction sequence; and
wherein the at least one interaction message includes an interaction message with a presentation start time later than the reference time, in the second interaction sequence.

4. The method of claim 2, wherein updating the first interaction sequence based on the extracted message content and presentation time information comprises:
adding the at least one interaction message to an end of the first interaction sequence to obtain the updated first interaction sequence, in accordance with a determination that each interaction message in the first interaction sequence matches the presentation time information of the at least one interaction message.

5. The method of claim 2, wherein updating the first interaction sequence based on the extracted message content and presentation time information comprises:
reordering, based on the presentation time information of the at least one interaction message, the at least one interaction message and an interaction message in the first interaction sequence to obtain the updated first interaction sequence, in accordance with a determination that the interaction message in the first interaction sequence fails to match the presentation time information of the at least one interaction message.

6. The method of claim 4, wherein updating the first interaction sequence based on the extracted message content and presentation time information further comprises:
adding the at least one interaction message to the first interaction sequence to obtain the updated first interaction sequence, in accordance with a determination that the first interaction sequence is an empty sequence; and
determining whether each interaction message in the first interaction sequence matches the presentation time information of the at least one interaction message, in accordance with a determination that the first interaction sequence is a non-empty sequence.

7. The method of claim 2, wherein the presentation time information of the at least one interaction message comprises at least one of:
a presentation start time of the at least one interaction message; or
a presentation duration of the at least one interaction message.

8. The method of claim 1, further comprising:
updating, based on the second sequence version information, the first sequence version information corresponding to the updated first interaction sequence.

9. The method of claim 1, wherein the update request comprises request version information of the update request; and wherein determining, based on the update response for the update request, received from the server, whether the first interaction sequence is to be updated comprises:
determining that the update response is a valid update response for the update request, in response to detecting that the update response includes the request version information; and
determining based on the valid update response, whether the first interaction sequence is to be updated.

10. The method of claim 1, further comprising:
for a first interaction message currently being presented and a second interaction message to be presented next, among the interaction messages of the predetermined type,
extending a time interval between a presentation start time of the second interaction message and a presentation start time of the first interaction message by adjusting a buffer time corresponding to the second interaction message, in accordance with a determination that the presentation start time of the second interaction message is earlier than a predicted presentation start time of the second interaction message; and
shortening a time interval between the presentation start time of the second interaction message and the presentation start time of the first interaction message by adjusting the buffer time corresponding to the second interaction message, in accordance with a determination that the presentation start time of the second interaction message is later than the predicted presentation start time of the second interaction message.

11. The method of claim 1, wherein presenting the interaction message of the predetermined type in the live streaming interface based on the result of the determination of the update for the first interaction sequence comprises:
sequentially presenting, in the live streaming interface, each interaction message in the updated first interaction sequence, based on a presentation start time and a presentation duration of the interaction message in the updated first interaction sequence, in accordance with a determination that the first interaction sequence is to be updated; and
sequentially presenting, in the live streaming interface, each interaction message in the current first interaction sequence, based on a presentation start time and a presentation duration of the interaction message in the current first interaction sequence, in accordance with a determination that the first interaction sequence is unneeded to be updated.

12. The method of claim 1, wherein sending, to the server, the update request for the first interaction sequence comprises:
sending, to the server, the update request for the first interaction sequence, in accordance with a determination that a user associated with the client corresponds to a predetermined user type.

13. The method of claim 12, wherein determining whether the user associated with the client corresponds to the predetermined user type is based on at least one of:
determining that the user associated with the client corresponds to the predetermined user type, in accordance with a determination that the user associated with the client is a streamer user; or
determining that the user associated with the client corresponds to the predetermined user type, in accordance with a determination that the user associated with the client has sent the interaction message of the predetermined type and a duration in which the interaction message is unpresented or presented in the live streaming interface is less than a predetermined duration.

14. The method of claim 1, wherein presenting the interaction message of the predetermined type in the live streaming interface comprises:
for a third interaction message currently presented in the live streaming interface, among the interaction messages of the predetermined type,
determining, in response to receiving a second instant message from the server, from the second instant message, additional information related to a presentation style of the third interaction message; and
updating, based on the additional information of the third interaction message, the presentation style of the third interaction message in the live streaming interface.

15. A method of presenting an interaction message, implemented at a server, the method comprising:
receiving an update request from a client, the update request indicating at least first sequence version information corresponding to a first interaction sequence, an interaction message in the first interaction sequence being an interaction message of a predetermined type, and the interaction message in the first interaction sequence being used to be presented in a live streaming interface at the client;
generating an update response for the update request based on a difference between the first sequence version information and second sequence version information corresponding to a second interaction sequence at the server; and
sending the update response to the client.

16. The method of claim 15, wherein generating the update response for the update request based on the difference between the first sequence version information and the second sequence version information corresponding to the second interaction sequence at the server comprises:
generating the update response based at least on the second sequence version information, in accordance with a determination that the second sequence version information is the same as the first sequence version information; and
generating the update response based at least on the second sequence version information and a message content and presentation time information of at least one interaction message of the predetermined type, in accordance with a determination that the second sequence version information is different from the first sequence version information.

17. The method of claim 15, further comprising:
for a newly added or updated fourth interaction message in the second interaction sequence, determining a presentation start time of the fourth interaction message based on a reference buffer time corresponding to the fourth interaction message, and a presentation start time and a presentation duration of a fifth interaction message located before the fourth interaction message in the second interaction sequence.

18. The method of claim 15, further comprising:
updating, in response to detecting that the second interaction sequence is changed, the second sequence version information corresponding to the second interaction sequence.

19. The method of claim 15, wherein for a server associated with a streamer user, the method further comprising:
synchronizing, in response to detecting that the second interaction sequence is changed, the changed second interaction sequence to a server associated with at least one live streaming participant.

20. An electronic device, comprising:
at least one processor; and
at least one memory coupled to the at least one processor and storing instructions for execution by the at least one processor, the instructions, when executed by the at least one processor, causing the electronic device to perform the method of:
presenting, in a live streaming interface, an interaction message in a first interaction sequence, the interaction message in the first interaction sequence being an interaction message of a predetermined type, and the interaction message in the first interaction sequence being received by the client from a server;
sending, to the server, an update request for the first interaction sequence, the update request indicating at least first sequence version information corresponding to the first interaction sequence;
determining, based on an update response for the update request, received from the server, whether the first interaction sequence is to be updated; and
presenting, based on a result of the determination of the update for the first interaction sequence, the interaction message of the predetermined type in the live streaming interface.
